(19) United States
(12) Patent Application Publication
(10) Pub. No.: US 2005/0253724 A1
(43) Pub. Date: Nov. 17, 2005

(54) Transponder

(76) Inventor: Anu Krappe, Tampere (FI)

Correspondence Address: FITCH EVEN TABIN AND FLANNERY, 120 SOUTH LA SALLE STREET, SUITE 1600, CHICAGO, IL, 60603-3406, US

(21) Appl. No.: 11/121,289

(22) Filed: May 3, 2005

Related U.S. Application Data
(63) Continuation of application No. PCT/FI03/00866, filed on Nov. 14, 2003.

(30) Foreign Application Priority Data
Nov. 20, 2002 (FI) 20022070

(51) Int. Cl. G08B 13/14

(52) U.S. Cl. 340/572.7; 257/679

(57) ABSTRACT

The present invention relates to a transponder comprising a first material layer (1) and a second material layer (4) attached to each other either directly or in such a manner that an intermediate layer exists between them. The first material layer has a front side and a back side, a circuitry pattern (3) is formed on the front side of the first material layer (1), and an integrated circuit on a chip (2) is electrically connected to the circuitry pattern (3). The second material layer (4) covers the front side of the first material layer (1) or the intermediate layer in such a manner that the circuitry pattern (3) is located between the first material layer (1) and the second material layer (4), or between the first material layer (1) and the intermediate layer. The second, material layer (4) is formed of a thermoplastic elastomer.

The present invention relates to a transponder comprising a first material layer and a second material layer attached to each other either directly or in such a manner that an intermediate layer exists between them, the first material layer having a front side and a back side, a circuitry pattern formed on the front side of the first material layer, and an integrated circuit on a chip electrically connected to the circuitry pattern, and the second material layer covering the front side of the first-material layer or the intermediate layer in such a manner that the circuitry pattern is located between the first material layer and the second material layer, or between the first material layer and the intermediate layer.

Counterfeiting and thefts are serious problems related to manufacturing of garments. An RFID (radio frequency identification) transponder, which is attached to the garment makes it easier to recognise an original garment. Each garment may have an individual code according to which it is easily traceable. Thefts are also easier to detect in a distribution chain because the garments having transponders can easily be inventoried, and each step in the distribution chain can be stored in a database of a manufacturer. Further, the transponder can be used for an electronic article surveillance, which decreases thefts in retail shops.

A new possible way of applying the RFID transponder is to use it for treating laundry; A wash machine can read washing instructions saved in the transponder, and choose a washing program accordingly. A wash machine can also alarm if a coloured cloth is among a white laundry.

Problems related to the use of the garment transponder are mainly derived from the fact that the transponder shall resist mechanical stress in its distribution chain and the washing conditions of the garment. The washing includes both chemical and mechanical stress against the transponder. The transponder should for example resist detergents, bleaching agents, and softeners. Further, it should resist high temperatures during ironing and steaming. Also during the use of the garment the transponder can come into contact with harmful substances, such as sweat, grease, or dust, and mechanical stress can occur due to the movement of the user of the garment. Problems related to the transponder are emphasized differently dependent on the final use of the transponder; If the transponder surveys the distribution chain the washability is not so important as with transponders intended for use with washing machines.

In addition to the above mentioned requirements, the transponder should be as imperceptible as possible, which means that the transponder must be flexible, thin, and light-weight. As to price, they should be cheap, and therefore the structure should be as simple as possible. For example, excess adhesive layers or excess film layers must be avoided.

On the contrary to the desired properties, most of the present transponders are rigid and thick, and can cause damages to garments and sores to users of the garments.

The present invention overcomes the above-mentioned defects. The transponder of the invention is characterized in that the second material layer is formed of a thermoplastic elastomer.

The transponder of the invention is flexible, imperceptible, and functions reliably for a long time. The long functioning time is due to an ability of the second material layer to resist impacts and protect the RFID circuit against water and chemicals. The second material layer prevents thus the copper leads to be oxidized. The second material layer can also be attached to another surface by a heat-sealing process, which produces a reliable bond and thus liquids cannot penetrate between the attached layers.

The second material layer is formed of a thermoplastic elastomer. The thermoplastic elastomer can be polyester polyurethane, polyether polyurethane, polycaprolacton polyurethane, or polyethylene-based rubber. A polyester polyurethane film is a preferred choice because polyester increases mechanical strength and chemical resistance, and prevents polyurethane to oxidize and degrade due to a thermal treatment. The thermoplastic elastomer is in a film form, and it is highly stretchable; Its elongation at break is between 400 to 800%. Suitable commercial products are for example polyester polyurethane films sold under trademarks Walopur® (Epurex Films, Germany), Gerband® (Gerlinger GmbH & Co. KG, Germany), and Frontier® (Alfapac AB, Sweden).

On the second material layer and/or on the back side of the first material layer may be at least one excess film layer. The excess layers bring more rigidity and mechanical strength to the transponder. The excess layer can be a coextrusion film formed of several materials, or it can be a film, which is attached to another layer by a heat-sealing process. The excess material layer, which is attached to the second material layer can also be a thermoplastic elastomer but the preferred choice in this case is polyurethane polyether film. Polyether increases certain properties of the film, such as water barrier properties, microbiological resistance, and resistance against low temperatures. The film can be selected for example amongst polyurethane polyether films sold under trademarks Walopur® (Epurex Films, Germany), Gerband® (Gerlinger GmbH & Co. KG, Germany), and Frontier® (Alfapac AB, Sweden).

Another possibility to form the transponder is to spread an intermediate layer comprising a suitable adhesive or varnish on the first material layer. On the intermediate layer is formed the second material layer, which can be for example be a modified polyethylene-based rubber film. Suitable films are for example TK 13086, TK 12524, and KG 5963.560 (Nordenia BV, Netherlands).

When compared to each other, the rigidity and the thickness of the films in the second material layer and the excess material layer may vary but they are selected so that the transponder maintains its flexibility. Different layers are selected so that the strength and the softness of the transponder are achieved by combining properties of the different material layers.

The material layers of the transponder are preferably attached to each other in a continuous manner, i.e. the layers consist of continuous webs. Also processing in a sheeted form is possible but the continuous process is more cost-effective. In the continuous process can be used high speeds and automatic process steps. An advantage related to processing in a sheeted form is that complicated structures can be built easier in this way.

The material layers are attached by the heat-sealing process in which the material layers are attached to each other by using heat and pressure, for example in a nip formed between two rolls from which at least one is a heated roll. The layers are pre-heated before attaching them to each other because of a fragility of the chip; In such a manner less pressure can be used. The pre-heating may be done by an infrared heater. The pressure, which is exerted to the chip can also be reduced by cutting a hole in the second material layer so that the chip can penetrate inside the hole during the heat-sealing process.

In the following, the invention is explained by an example and referring to the following figures in which

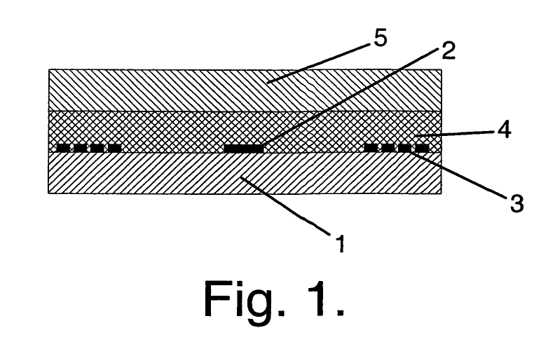

FIG. 1 shows a transponder in a cross-sectional view,

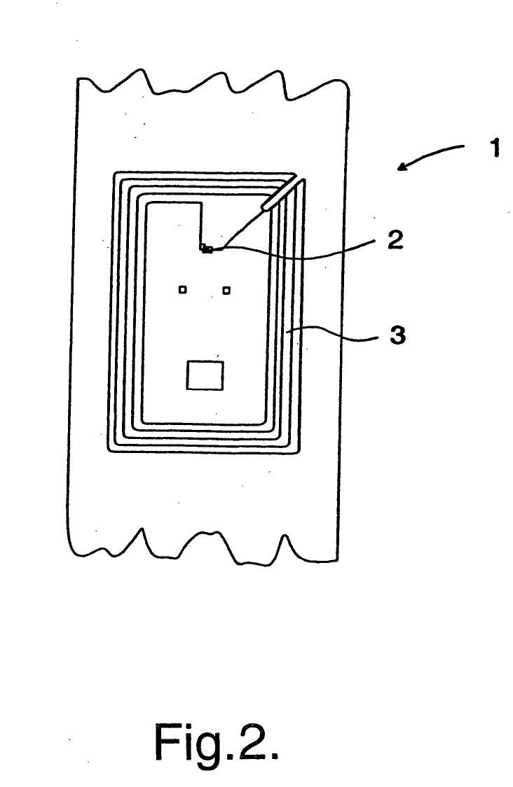

FIG. 2 shows a carrier layer of a transponder, and

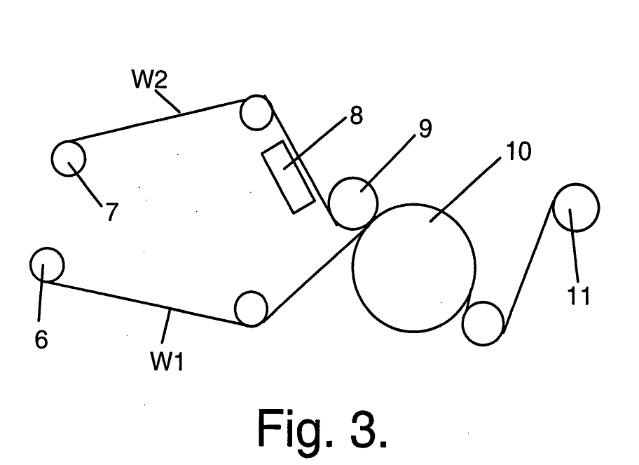

FIG. 3 shows a schematic view about a process for manufacturing transponders.

### EXAMPLE

A garment transponder according to the invention was manufactured. The structure of the garment transponder in a cross-sectional view is shown in FIG. 1. The garment transponder comprises a first material layer, which is called a carrier layer 1 in this context, and a second material layer, which is called a water barrier layer 4. The garment transponder may also include an excess layer 5 but from some embodiments of the invention it may be omitted.

A carrier layer 1 in a top view is shown in FIG. 2. A circuitry pattern 3 is formed on the carrier layer 1, and an integrated circuit on a chip 2 is attached to the carrier layer 1 in such a manner that it is electrically connected to the circuitry pattern 2. The chip can be attached directly to the circuitry pattern, or a piece of a polymeric material including the chip on its surface is attached to the circuitry pattern. The circuitry pattern can be made by printing the circuitry pattern on a film with an electroconductive printing ink, by etching the circuitry pattern on a metal film, or by punching the circuitry pattern off a metal film. The circuitry pattern is provided with an identification circuit, such as a radio frequency identification (RFID) circuit. The identification circuit is a simple electric oscillating circuit (RCL circuit) tuned to operate at a defined frequency. The circuit consists of a coil, a capacitor and an integrated circuit on a chip, consisting of an escort memory and an RF part for communication with a reader device. Instead of the coil, a dipole antenna can be used. The capacitor of the RCL circuit can also be integrated on the chip, or it can be outside the chip, i.e. it can be formed for example on the carrier layer.

The carrier layer and other layers on it are processed preferably in web form, and ready transponders are cut from the web. The web contains circuitry patterns 3, each having an integrated circuit 2, at suitable spaces one after another and/or next to each other.

In FIG. 3 is shown one possible way of manufacturing the transponder of the invention. A web W1 comprising successive and/or adjacent circuitry patterns is unwound from a roll 6, and a web W2, which material is of thermoplastic elastomer, is unwound from a roll 7. An infrared heater 8 heats the web W2 before it is led to a nip formed between a roll 9 and a heated roll 10. The webs W1 and W2 are attached to each other in the nip, and after that the web travels forward in contact with the surface of the heated roll 10. The tension of the web produces the required slight pressure. The ready web is reeled up to a roll 11.

The invention is not restricted to the above described embodiments but may vary in the scope of the claims. In addition to garment transponders, the transponders of the invention can be used in other applications where a flexible and water-impermeable transponder is required.

1. A transponder comprising a first material layer and a second material layer attached to each other either directly or in such a manner than an intermediate layer exists between them, the first material layer having a front side and a back side, a circuitry pattern formed on the front side of the first material layer, and an integrated circuit on a chip electrically connected to the circuitry pattern, and the second material layer covering the front side of the first material layer or the intermediate layer in such a manner that the circuitry pattern is located between the first material layer and the second material layer, or between the first-material layer and the intermediate layer, wherein the second material layer is formed of a thermoplastic elastomer.

2. The transponder according to claim 1, wherein the transponder is a garment transponder.

3. The transponder according to claim 1 wherein the thermoplastic elastomer includes polyester polyurethane.

4. The transponder according to claim 2 wherein the thermoplastic elastomer includes polyester polyurethane.

5. The transponder according, to claim 1 wherein the thermoplastic elastomer includes polyether polyurethane.

6. The transponder according to claim 2 wherein the thermoplastic elastomer includes polyether polyurethane.

7. The transponder according to claim 1 wherein the thermoplastic elastomer includes polycaprolactone polyurethane.

8. The transponder according to claim 2 wherein the thermoplastic elastomer includes polycaprolactone polyurethane.

9. The transponder according to claim 1 wherein the thermoplastic elastomer includes polyethylene-based rubber.

10. The transponder according to claim 2 wherein the thermoplastic elastomer includes polyethylene-based rubber.

11. The transponder according to claim 1 wherein the intermediate layer is an intermediate composition selected from the group consisting of adhesive and a varnish.

12. The transponder according to claim 1 wherein the transponder further comprises at least one additional material layer on the thermoplastic elastomer layer and/or on the back side of the first material layer.

13. The transponder according to claim 1 wherein the material layers are attached to each other by heat-sealing.

14. The transponder according to claim 12 wherein the material layers are attached to each other by heat-sealing.

15. A radio frequency identification transponder which is effective for attachment to a garment, the transponder comprising:
a first material layer having a front and back surface;
a circuitry pattern on the front surface of the first material layer;
an integrated circuit on a chip electrically connected to the circuitry pattern;
a thermoplastic elastomer film overlying the circuitry pattern on the first material layer, the thermoplastic elastomer film selected from the group consisting of polyester polyurethane, polyether polyurethane, polycaprolactone polyurethane, and polyethylene-based rubber.

16. The radio frequency identification transponder according to claim 15 wherein the first material layer and the thermoplastic film are heat sealed to one another.

17. The radio frequency identification transponder according to claim 15, the transponder further comprises at least one additional layer on the thermoplastic elastomer film.

18. The radio frequency identification transponder according to claim 15, the transponder further comprises at least one additional layer on the back surface of the first material layer.

19. The radio frequency identification transponder according to claim 17, the transponder further comprises at least one additional layer on the back surface of the first material layer.

20. The radio frequency identification transponder according to claim 17, wherein the additional layer comprises a thermoplastic elastomer.

21. The radio frequency identification transponder according to claim 18, wherein the additional layer comprises a thermoplastic elastomer.

22. The radio frequency identification transponder according to claim 17, wherein the additional layer comprises a polyurethane polyether film.

23. The radio frequency identification transponder according to claim 18, wherein the additional layer comprises a polyurethane polyether film.

24. A radio frequency identification transponder which is effective for attachment to a garment, the transponder comprising:
a first material layer having a front and back surface;
a circuitry pattern on the front surface of the first material layer;
an integrated circuit on a chip electrically connected to the circuitry pattern;
an intermediate layer overlying the front surface of the first material layer, the intermediate layer selected from the group consisting of an adhesive layer and a varnish layer; and
a thermoplastic elastomer film overlying the intermediate layer on the first material layer, the thermoplastic elastomer film selected from the group consisting of polyester polyurethane, polyether polyurethane, polycaprolactone polyurethane, and polyethylene-based rubber.

25. The radio frequency identification transponder according to claim 24, wherein the transponder further comprises at least one additional film layer on the thermoplastic elastomer film.

26. The radio frequency identification transponder according to claim 24, the transponder further comprises at least one additional film layer on the back surface of the first material layer.

27. The radio frequency identification transponder according to claim 25, the transponder further comprises at least one additional film layer on the back surface of the first material layer.

28. The radio frequency identification transponder according to claim 25, wherein the additional film layer comprises a thermoplastic elastomer.

29. The radio frequency identification transponder according to claim 28, wherein the additional film layer comprises a thermoplastic elastomer.

30. A method for making a radio frequency identification transponder, the method comprising:
providing a first material layer having a front and back surface, the front surface having a circuitry pattern and an integrated circuit on a chip electrically connected to the circuitry pattern;
applying a thermoplastic elastomer film over the front surface of the first material layer, the thermoplastic elastomer film selected from the group consisting of polyester polyurethane, polyether polyurethane, polycaprolactone polyurethane, and polyethylene-based rubber; and
heat sealing the first material layer to the thermoplastic film.

31. The method according to claim 30, the method further comprising applying an additional layer over the thermoplastic elastomer film.

32. The method according to claim 30, the method further comprising applying an additional layer over the back surface of the first material layer.

33. The method according to claim 31 further comprising applying an additional layer over the thermoplastic elastomer film.
